(19) United States
(12) Patent Application Publication
(10) Pub. No.: US 2009/0299497 A1
(43) Pub. Date: Dec. 3, 2009

(54) Tolerance interval determination method

(75) Inventors: Stephen N. Luko, Terryville, CT (US); David P. McDermott, Suffield, CT (US)

Correspondence Address: Theodore F. Neils;Kinney & Lange, P. A., THE KINNEY & LANGE BUILDING, 312 South Third Street, Minneapolis, MN, 55415-1002, US

(73) Assignee: United Technologies Corporation, Hartford, CT (US)

(21) Appl. No.: 12/156,143

(22) Filed: May 30, 2008

(51) Int. Cl. G05B 13/04; G06F 17/18

(52) U.S. Cl. 700/29; 702/181

(57) ABSTRACT

A method for containing a fraction of values of a measurable characteristic of interest, occurring in process outcomes provided from a corresponding formation process, within tolerance limits based on samples thereof, the tolerance limits being based on a different formation process by which similar process outcomes are known to have been previously through selecting a probability representation over a representational variable to represent the distribution of values of the measurable characteristic of interest in the formation processes outcomes and using a selected Monte Carlo method with the probability representation to provide a plurality of sample values sets for the measurable characteristic of interest each containing a common selected number of sample values. A statistic is formed to test selected tolerance limits to find a value for tan incremental variable to assure those tolerance limits will be met with a selected confidence.

### BACKGROUND

The present invention relates to characterizing geometrical shapes of objects with respect to specifications therefor through various measurements thereof and, more particularly, to characterizing them statistically with respect to such specifications determined therefor through such measurements of selected samples thereof.

Commonly, components for use in manufactured entities, such as various machines, have some set of component features peculiar thereto that are required to meet specified spatial, or other kinds, of tolerances to thereby result in those components being acceptable for subsequent use in the manufacturing process for providing such entities. Whether the manufacturing process is for the component themselves, or for the entities desired to result from assembly thereof, various features of the outcomes of those processes will be measurable, and the measuring thereof will accumulate test data on those measurable features which will demonstrate how much those features in the process outcomes vary in value during the operation of the process, as such variation occurs in every kind of manufacturing process.

In the efforts made to control the outcomes of a manufacturing process to thereby assure that various measurable features of the outcome devices resulting from that manufacturing process meet whatever tolerance limits have been specified therefor, various measurements characterizing these measurable outcome features are typically made with respect to a selected sample or samples of such process outcome devices. That is done because characterizing every one of such process outcome devices with a full set of measurements of their measurable features of interest will be either too costly or too time consuming, or both, in at least those situations in which substantial numbers of such devices are provided through the manufacturing process. Such feature measurements are compared to specifications previously set to determine the acceptability of the process outcome devices so measured for use in subsequent entity manufacturing processes, or for direct sale in any markets therefor, or both.

Because these feature measurements are made typically on only a relatively few process outcome devices in the sample or samples thereof, pertinent statistical analyses of the measured values of the measurable features in process outcome devices in the sample or samples are used to characterize the performance of the corresponding manufacturing process or processes. If nothing about the process outcome devices is assumed as to the probability distributions of their measurable features over the possible ranges of the various measurable feature outcomes occurring in those manufacturing process outcome devices, resort must be had to nonparametric statistical methods based on order statistics as the basis for setting the feature specification limit values. Such statistical methods typically result in finding relatively large ranges over which the process feature outcomes can be expected to occur, and so often provide relatively little assurance that the manufacturing process can provide process outcome devices meeting the various device features specifications.

Thus, the ranges of feature outcomes from such manufacturing processes are usually instead analyzed using parametric statistical methods, and each feature outcome range is typically assumed, and usually reasonably confirmed so subsequently, to be characterized by a normal probability distribution of the feature outcome values over that range for the process outcome devices. Such a distribution for each of the measureable feature outcomes is representable by two process parameters, the process outcome device feature values mean, μ, i.e. the feature values arithmetical average for the measured feature outcomes, and by the process outcome device feature values standard deviation, a, for those same process feature outcome devices. A sample is then selected comprising a selected number n of the manufacturing process outcome devices resulting from such a manufacturing process that is then in statistical control, i.e. the feature outcomes that are of interest in each of the process outcome devices all being within the expected range of variation. Thereafter, each device feature outcome of interest in each of those process outcome devices in this sample is measured to thereby provide a measured value, xᵢ, corresponding thereto. These measurements can be used to provide an estimated value, \hat{μ}, of the mean λ of that process outcome device feature [\hat{μ}=(x₁+x₂+ . . . xᵢ . . . +xₙ)/n] and an estimated value, \hat{σ}, of the standard deviation σ of that process outcome device feature [\hat{σ}={(x₁−\hat{μ})²+(x₂−\hat{μ})² . . . +(xᵢ−\hat{μ})²}/(n−1)], these estimates each being seen to have a value depending on the count size n of the sample selected.

The measurement, or test, data accumulated for samples of these process outcome devices usually originates from several distinct lots of each such outcome devices with each such lot typically having been produced at a time differing from the others. These different lots are likely to have some differences between them in the constituent component characteristics, i.e. lot-to-lot variability, because of the time order of production leading to changes in the various process variables such as lot material changes, production tooling changes, process parameter variability, process operator effects, etc. Other causes of such variability in lots is that some component features may be measured more than once, i.e. repeated in some way, with differences occurring between one measurement and the next reflecting some aspect of measurement error if the same feature is measured, or some degree of “within part” variation if the same feature is measured but at differing locations or datum positions; An analysis of feature measurement data variance allows partitioning that variance into variance components due to these different causes thereof.

Thus, a typical outcome devices measurement situation is one in which n such devices are drawn from a normally distributed population of such parts that each have a measured outcome x which may have been measured m times. The variance thereof can be divided into variance components, through a variance analysis of the resulting data, and represented as estimated component standard deviations such as \hat{σ}ₛₙ=estimated true part standard deviation and \hat{σ}_{w}=estimated within part or measurement error standard deviation. In addition, there will be lot-to-lot variation represented as the estimated standard deviation \hat{σ}ₗₒₜ.

Such estimates can be used in a first manner, based on normally distributed process outcome device features, to determine a prediction interval for each feature outcome value to be next observed with a selected confidence, or probability. Such intervals are known to be predicted using the Student's t-distribution to provide that interval which is centered on the estimated process outcome device feature sample values mean \hat{μ} but separated from that mean value on either side thereof by a value depending on a function of the process outcome device feature sample values standard deviation \hat{σ} (comprising the variance component standard deviations described just above suitably combined), multiplied by the appropriate value for t. These prediction intervals will be narrower than the ranges found for the process outcome device features found using nonparametric statistics because of the use of the knowledge that probability distributions involved with the process outcome device features are normal.

The possible tolerance band can usually be narrowed further by using, instead, the knowledge of a normal probability distribution directly to determine a normal tolerance interval that has within it a selected fraction of the process outcome device feature values with a selected confidence, or probability. Such an interval is again centered on the estimated process outcome device feature values mean \hat{μ} but separated from that mean value on either side thereof by a value depending on a function of the process outcome device sample values standard deviation \hat{σ} (again comprising the variance component standard deviations described just above suitably combined), multiplied by a factor h that is found in such a determination.

Such sampling and statistical methods can be used process outcome prototype devices in designing new manufacturing processes for components, and manufactured entities using such components, as part of the basis for establishing the specifications to be used for the various measurable features in the process outcome devices. However, situations arise in which such process outcome devices have been previously manufactured in an earlier established manufacturing process but where the manufacturing process used, and the design therefor, are not now available. A sampling of the measurable features of interest of components or entities that remain available from the now unavailable manufacturing process can be used to provide both the estimated process outcome device feature sample values mean \hat{μ} and the process outcome device feature sample values standard deviation \hat{σ}. Assuming a normal probability distribution for the feature range of values that is inferred from these sample statistics can be used to determine the necessary capabilities needed in the new manufacturing process to provide components or entities as process outcomes with the features of interest having values within corresponding tolerance bands based on these resulting distributions.

However, although an improvement in narrowing the possible tolerance band to be specified for the new process outcome occurs with resort to the latter of the foregoing methods, the resulting interval will still likely be relatively large, especially when based on small sample sizes. Thus, there is a desire for a better method in selecting tolerance bands for measurable features of interest in new manufacturing process outcome devices, which are to be made to more or less match the devices resulting from the previous manufacturing process, so that this improved method results in relatively narrower tolerance bands.

### SUMMARY

The present invention provides a method for containing a fraction of values of a measurable characteristic of interest, occurring in process outcomes provided from a corresponding formation process, within tolerance limits based on samples thereof, the tolerance limits being based on a different formation process by which similar process outcomes are known to have been previously provided by selecting a probability representation over a representational variable to represent the distribution of values of the measurable characteristic of interest in the formation processes outcomes and using a selected Monte Carlo method with the probability representation to provide a plurality of sample values sets for the measurable characteristic of interest each containing a common selected number of sample values. This is followed by determining a sample mean and a sample standard deviation of the selected number of sample values in each of the plurality of sample value sets and forming a statistic by summing the sample mean with the sample standard deviation as multiplied by a common incrementing variable for each of the plurality of sample value sets to form a plurality of sample value sets statistics. Increasing the magnitude in selected increments of the incremental variable until a selected fraction of the plurality of sample value sets statistics are outside selected tolerance limits determines a value for the incremental variable to assure those tolerance limits will be met with a selected confidence.

### BRIEF DESCRIPTION OF THE DRAWINGS

FIGS. 1A and 1B show a flow chart representing the method embodied in the present invention.

### DETAILED DESCRIPTION

A manufacturing process is taken to be in statistical control if the unavoidable variation in the measured values of the various process outcomes is within the range of expected process natural variation therefor. This range is often taken, for a process that either is assumed to have, or actually has, normally distributed outcomes, as being outcome variation that is within three estimated standard process outcomes standard deviations \hat{σ} of the estimated process outcomes mean \hat{μ}.

In accord, a process capability index, Ĉₚₖ, has been defined that estimates the performance capability of the process based on this variation limit if the process is being operated such that its mean outcomes values are centered between the upper and lower outcome specification limits, USL and LSL. This index is given by

$${\hat{C}}_{pk} = min [ \frac{USL - \hat{μ}}{3 \hat{σ}} , \frac{\hat{μ} - LSL}{3 \hat{σ}} ]$$

which can be seen to be based on this three estimated standard process outcomes standard deviations criterion

The greater the value of this index, the further the specification limits are from the process mean for a process operating centered on the mean with typical values of the index being 1.33 and 1.5. Thus, Ĉₚₖ=1.5 indicates that the process is operating with the centered process mean \hat{μ} being 4.5 \hat{σ} away from the process specification limits.

In the situation in which a component or entity is to be fabricated by a manufacturer in a new manufacturing process that is to provide process outcomes that substantially match those from a previously established manufacturing process not now available, the assumptions that the previous process was operated in statistical control with a reasonable value for the process capability index Ĉₚₖ allows determining the tolerance band used with the well established previous process. If a number of such previously manufactured process outcome devices were successfully manufactured over time, the assumptions are likely to be true that the earlier manufacturing process was operated so as to have been in statistical control such that the values of the measurable features of interest for each process outcome device were centered on the estimated mean value thereof in accord with the process capability index Ĉₚₖ value used in that process.

Thus, components available from this other earlier established component manufacturing process, in the absence of corresponding specifications, can have the measurable features of interest therein sampled to find the sample mean and sample standard deviation therefor to be used to help establish the necessary capabilities for the new process, and the those features in the new process outcome components can be sampled to assure they are meeting the corresponding tolerance bands specified therefor as they result from practicing this new process. The use of these assumptions for a well established process allows knowing how narrow the tolerance bands can be, through this incorporation of the experience gained in practicing the earlier established process, rather than having to establish tolerance bands based only on the assumption of normally distributed values for the process outcomes features of interest and future process practice experience.

Hence, on the assumption that previously established successful manufacturing processes were practiced such that the process outcome components have their measurable features of interest with values distributed normally and centered about the process outcomes mean, and in accord with a typical process capability index for Ĉₚₖ assumed used in the earlier process, the corresponding upper and lower specification limits (the tolerance bands being between them) for each such feature are then determined from the preceding equation. A separation interval is found, \hat{μ}−k\hat{σ} to \hat{μ}+k\hat{σ}, based on n samples of the process outcome components in a sample set, the assumed value of Ĉₚₖ, and that the process is centered, leads to a separation width across that interval which depends on the value of k. Thus, there is sought a value of k, for the size n of the sample available, that assures that a selected fraction of such separation intervals for the feature of interest over the range of outcomes for samples of that size is contained within the corresponding feature tolerance band.

The value found for k to result in such a fraction leads to an inclusion interval of \hat{μ}−k\hat{σ} to \hat{μ}+k\hat{σ} set by that value of k for that sample size n. However, different inclusion intervals are found for different sample sizes n, that is, the separation width of an inclusion interval has a magnitude that depends on the value of the corresponding sample size number n. This dependence comes about because smaller numbers n of samples of the process outcome components results in a corresponding smaller number of values for a feature being available to estimate the mean and standard deviation of the feature values distribution leading to larger variations thereof. This increase in variation in the sample means and standard deviations for that feature necessitates a smaller value for k for smaller sample sizes n to satisfy having a selected fraction of the separation intervals within the corresponding feature tolerance band.

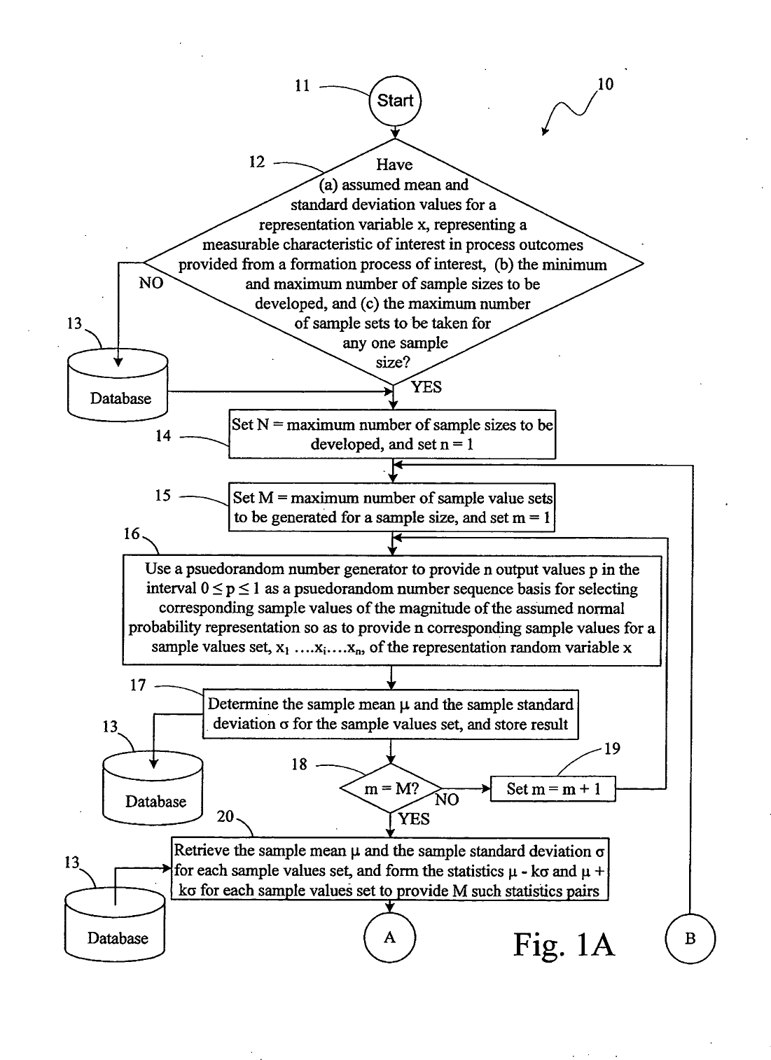

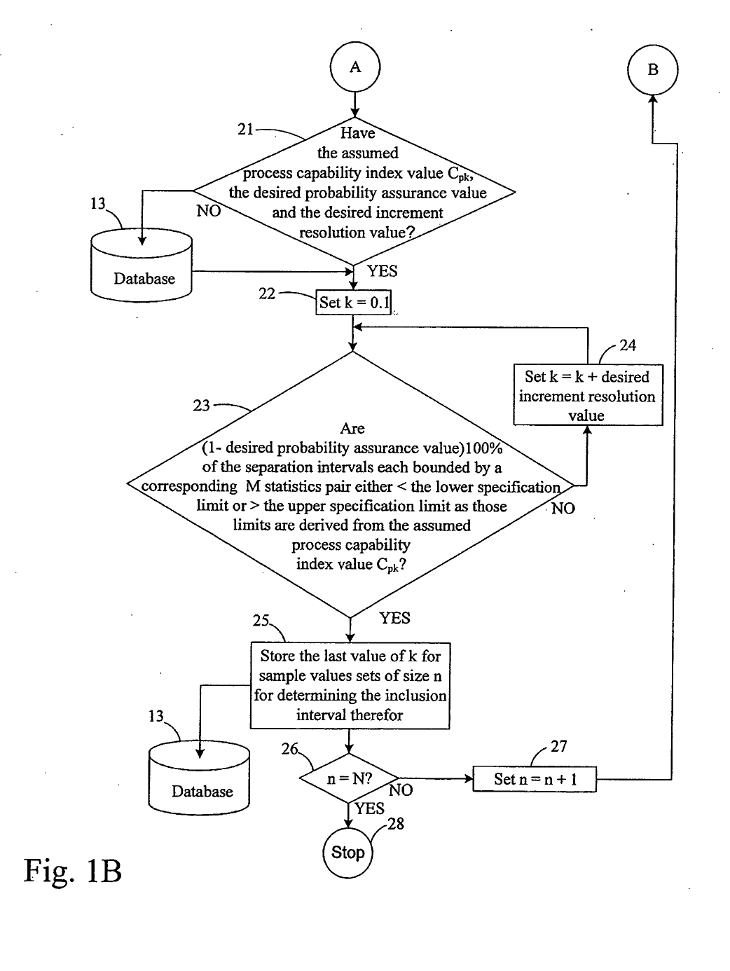

Values for k in setting the inclusion interval magnitude for various sample numbers n, i.e. sample sizes, are determined by using a Monte Carlo method for simulating the sampling of the values, xᵢ, as a feature representation random variable, that are, or are scalable to correspond with, the values of the measurable feature of interest in each corresponding sample of the process outcome devices. This determination process is represented in the flow chart, 10, of FIGS. 1A and 1B starting in a start balloon, 11, in FIG. 1A. The Monte Carlo method for simulating this sampling is based, typically, on assuming that feature sampling values are normally distributed, and so uses the representation variable x therefor as having a standardized normal distribution. The mean μ for the feature representational values in this standardized distribution is taken as μ=0 and the standard deviation σ for the feature representational values is taken as σ=1.

The method begins with a suitable computer system being provided with, or obtaining, these selected values for the representational values mean and standard deviation. This acquisition of these values thereby establishes in the computer system the assumed standardized normal distribution that the computer system will sample from in implementing the Monte Carlo method chosen, as is indicated in a decision diamond, 12. In addition, the computer system must obtain the minimum and maximum number of sample sizes to have a corresponding value of k developed therefor, and also obtain the maximum number of sample sets to be taken by the computer system and used in determining the k value for the inclusion interval to be developed for each corresponding sample size of interest. The computer system determines there whether such data is already in the computer system or, instead, must be retrieved from a database facility, 13, in which that data has been stored and, so, from which this retrieval is thereafter made.

With this data, the computer system, in a performance block, 14, sets a count register to the value N for the maximum number of sample sizes to have a corresponding value of k developed therefor, and sets a counting register to the value n=1 in developing the value of k corresponding to a sample size of 1 as the initial sample size to be considered. In a further performance block, 15, the computer system sets a count register to the value M for the maximum number of samplings of size n (i.e., the number of sample sets of size n) to be taken by the computer through the Monte Carlo method used in developing the corresponding value of k, and sets a counting register to the value m=1 to begin sequencing through the generating of these sample sets until M of them have been taken.

Thereafter, the computer system undertakes, in another performance block, 16, the generation of a sample set of size n (where n=1 in the first instance) through using a Monte Carlo simulation. This is accomplished through using a pseudorandom number generator in the computer system to provide n output values in the interval of 0≦p≦1 as a pseudorandom number sequence basis for selecting corresponding sample values of the probability magnitude of the assumed standardized normal probability distribution. The cumulative distribution method is employed for this purpose. Thus, an m^{th} set of n sample values, x₁ . . . xᵢ . . . xₙ, is thereby formed corresponding to the desired sample size n (again, where n=1 in the first instance, and, of course, where m=1 for the first such sampling).

The n sample values in the completed samples values set are then used to determine the m^{th} sample set mean value \hat{μ} (an estimate of the distribution mean value μ) and the m^{th} sample set standard deviation value \hat{σ} (an estimate of the distribution standard deviation σ) using the equations given therefor above in a further decision block, 17. These values for this m^{th} sample set are then stored in database facility 13. The count value of m is then checked in a decision diamond, 18, to determine whether or not it has reached the value M for the maximum number of samplings of size n which typically can be on the order of 10,000 to 100,000 such computer based samplings. If not, the register holding the value m is incremented by one count in a performance block, 19, and the sample set generation process for sample size n is repeated in block 16 to form sample set m+1 followed by determining its mean and standard deviation in block 17 until m=M.

When the count value of m does reach the value M for the maximum number of samplings of size n, the stored values of the sample sets means and standard deviations for each sample set of size n are retrieved in a subsequent performance block, 20. These retrieved values of the sample set mean and standard deviation for each sample set of size n are used to form the corresponding pair of statistics, \hat{μ}−k\hat{σ} and \hat{μ}+k\hat{σ}, for each such sample set. This pair of statistics will be used in finding the inclusion interval described above for values of a component feature when a sample set of size n is relied upon to indicate that the desired fraction of values of that feature in the process outcome components is within the lower and upper specification limits therefor. Thus, the computer system will form M pairs of such paired statistics for each sample size n as will be shown below.

Finding the inclusion interval for a component feature value for a sample set of size n requires the computer system to obtain further data which is undertaken first in FIG. 1B. The transition path from FIG. 1A to FIG. 1B is indicated by a transition balloon, A, in each figure. This includes in a decision diamond, 21, obtaining the assumed value for the process capability index Ĉₚₖ to allow determining from the corresponding equation given above the values for the lower and upper specification limits for the values of the representation variable x, as distributed in the standard normal distribution also indicated above. These limits are scalable to the values of the feature of interest since the equation for the process capability index Ĉₚₖ is useable with any normal distribution.

In addition, in block 21, the computer system obtains the desired probability assurance value as to the fraction of the separation intervals, bounded by the pair of statistics \hat{μ}−k\hat{σ} and \hat{μ}+k\hat{σ} for the sample sets of size n, that are desired to be within those lower and upper specification limits found from the process capability index Ĉₚₖ. A typical fraction value to serve as the desired probability assurance value would be 95%. Also, the computer system obtains the desired increment resolution value to be used in sequentially increasing the value of k from an initial value to thereby sequentially increase the separation interval between these paired statistics in each of the m sample sets until a k value is found to just leave the desired fraction of separation intervals between the specified tolerance limits, i.e. to determine the inclusion interval for sample sets of size n. A typical desired increment resolution value would be 0.01.

The computer system, having a k value register therein that will accumulate the increases in the value of k in the search for a value thereof to establish the inclusion interval for samples of size n, initially sets that register to the value k=0.1 to begin developing the value of k corresponding to that sample size in a following performance block, 22. This value of k is checked in a subsequent decision diamond, 23, to determine if this last value of k has been sufficient to force (1−desired probability assurance value) 100% of the M statistics pairs bounded separation intervals to be either less than, or exceed, the lower and upper specification limits found from the process capability index Ĉₚₖ. If not, the register holding the value k is incremented by the desired increment resolution value in a performance block, 24, and this new value of k is then checked in decision diamond 23 to determine if this last value of k has been sufficient to force (1−desired probability assurance value) 100% of the M statistics pairs bounded separation intervals to be either less than, or exceed, the lower and upper specification limits. This incrementing of k and checking on whether a desired fraction of the M statistics pairs bounded separation intervals has become either less than, or exceed, the lower and upper specification limits repeats until that fraction of those separation intervals do so.

When the value of k is sufficient to force (1−desired probability assurance value) 100% of the M statistics pairs bounded separation intervals to be either less than, or exceed, the lower and upper specification limits, this value of k is stored by the computer system acting under a succeeding performance block, 25, in database facility 13 which sets the inclusion interval for samples values sets of size n. Thereafter, the sample size value n is checked in a last decision diamond, 26, to determine whether or not it equals the maximum number N of sample sizes desired to have a corresponding value of k developed therefore. Typically, N will be kept in the range of 25 to 30 as the variation in the mean and standard deviation of samples is much reduced by sample sizes this large or larger leading nearly constant values being found for k for such sample sizes.

If n does not yet equal N, the register holding the value n is incremented by one count in a performance block, 27, and the inclusion interval determination process for the next sample size n is repeated beginning in block 15 until n=N. If n is found to equal N in decision diamond 26, the process of developing k values to set inclusion intervals for corresponding sample sizes n concludes in a stop balloon, 28. Table 1 following provides a tabular listing example of values of k for different sample sizes n using Ĉₚₖ=1.5.

TABLE 1

| n | Cpk | k-value |
|---|---|---|
| 4 | 1.5 | 2.445 |
| 5 | 1.5 | 2.640 |
| 6 | 1.5 | 2.760 |
| 7 | 1.5 | 2.860 |
| 8 | 1.5 | 2.960 |
| 9 | 1.5 | 3.005 |
| 10 | 1.5 | 3.080 |
| 11 | 1.5 | 3.120 |
| 12 | 1.5 | 3.155 |
| 13 | 1.5 | 3.215 |
| 14 | 1.5 | 3.245 |
| 15 | 1.5 | 3.275 |
| 16 | 1.5 | 3.310 |
| 17 | 1.5 | 3.335 |
| 18 | 1.5 | 3.365 |
| 19 | 1.5 | 3.380 |
| 20 | 1.5 | 3.415 |
| 21 | 1.5 | 3.420 |
| 22 | 1.5 | 3.460 |
| 23 | 1.5 | 3.465 |
| 24 | 1.5 | 3.495 |
| 25 | 1.5 | 3.515 |

Since the dimensionless value selected for Ĉₚₖ is equated to the ratio of two intervals along the axis of the random variable over which the normal distribution therefor occurs, and these intervals are formed by the parameters determining normal distributions, the k-values found for the selected value of Ĉₚₖ are useable with any normally distributed random variable. Thus, retaining the same Ĉₚₖ value and using the differing mean and standard deviation characterizing some other formation process allows determining the LSL and USL for that process with the same fraction of the separation intervals occurring between them based on the k-values found for the earlier formation process for corresponding sample sizes.

In situations in which process outcome devices have been previously manufactured in an earlier established manufacturing process, and the manufacturing process used, and the design therefor, are not now available, the foregoing method allows establishing suitable tolerances for the device features. Such situations arise in attempting to “reverse engineer” a competitor's product, or the product of a vendor no longer able or willing to supply same, or your own former product from a terminated formation process. A sampling of the measurable features of interest of the n components or entities that become or remain available from such now unavailable manufacturing processes can be used with the foregoing method to provide suitable feature tolerance bands. This depends upon assuming a normal probability distribution for the feature range of values in the earlier process that was being operated at the center of its tolerance band, and a value for Ĉₚₖ. As the table above shows, the width of the tolerance bands narrows for features with the availability of a larger number n of the components or entities from the earlier process which can then serve to reduce the uncertainty involved in knowing the range of values for a feature.

Although the present invention has been described with reference to preferred embodiments, workers skilled in the art will recognize that changes may be made in form and detail without departing from the spirit and scope of the invention.

1. A method for containing a fraction of values of a measurable characteristic of interest, occurring in process outcomes provided from a corresponding current formation process, within tolerance limits based on samples of a different formation process by which similar process outcomes are known to have been previously provided, the method comprising:
selecting a probability representation over a representational variable to represent the distribution of values of the measurable characteristic of interest in the formation processes outcomes,
using a selected Monte Carlo method with the probability representation to provide a plurality of sample values sets for the measurable characteristic of interest each containing a common selected number of sample values,
determining a sample mean and a sample standard deviation of the selected number of sample values in each of the plurality of sample value sets,
forming a statistic by summing the sample mean with the sample standard deviation as multiplied by a common incrementing variable for each of the plurality of sample value sets to form a plurality of sample value sets statistics, and
increasing the magnitude in selected increments of the incremental variable until an incremental variable determined value is reached at which a selected fraction of the plurality of sample value sets statistics are outside the selected tolerance limits.

2. The method of claim 1 wherein the probability representation is a normal probability distribution.

3. The method of claim 1 further comprising the using, determining, forming and increasing therein being repeated for each of different values for the common selected number of sample values.

4. The method of claim 1 wherein the tolerance limits being derived through a different formation process are found based on assuming that different formation process to have been operated to provide process outcomes centered on the average between the tolerance limits used therewith.

5. The method of claim 1 wherein the tolerance limits for the measurable characteristic of interest occurring in process outcomes provided from the corresponding current formation process are determined at least in part by the incremental variable determined value found with respect to measured values of those features of interest in a corresponding number of process outcomes available from the other formation process.

6. The method of claim 2 further comprising the using, determining, forming and increasing therein being repeated for each of different values for the common selected number of sample values.

7. The method of claim 2 wherein the tolerance limits being derived through a different formation process are found based on assuming that different formation process to have been operated to provide process outcomes centered on the average between the tolerance limits used therewith.

8. The method of claim 2 wherein the tolerance limits for the measurable characteristic of interest occurring in process outcomes provided from the corresponding current formation process are determined at least in part by the incremental variable determined value found with respect to measured values of those features of interest in a corresponding number of process outcomes available from the other formation process.

9. The method of claim 5 further comprising ascertaining at least in part the needed capabilities for the current formation process through determining the tolerance limits for the measurable characteristic of interest occurring in process outcomes provided from the other formation process.

10. The method of claim 8 further comprising ascertaining at least in part the needed capabilities for the current formation process through determining the tolerance limits for the measurable characteristic of interest occurring in process outcomes provided from the other formation process.

11. The method of claim 9 further comprising reverse engineering at least in part the other formation process through determining the tolerance limits for a plurality of measurable characteristics of interest occurring in process outcomes provided from the other formation process.

12. The method of claim 10 further comprising reverse engineering at least in part the other formation process through determining the tolerance limits for a plurality of measurable characteristics of interest occurring in process outcomes provided from the other formation process.
